(19) United States
(12) Patent Application Publication
(10) Pub. No.: US 2021/0239039 A1
(43) Pub. Date: Aug. 5, 2021

(54) Optimal Efficiency Internal Combustion Engine

(71) Applicants: Glen Alton Collett, Sandy, UT (US); Ernest Emanuel Rogers, Pleasant Grove, UT (US)

(72) Inventors: Glen Alton Collett, Sandy, UT (US); Ernest Emanuel Rogers, Pleasant Grove, UT (US)

(21) Appl. No.: 17/160,356

(22) Filed: Jan. 27, 2021

Related U.S. Application Data
(60) Provisional application No. 62/969,090, filed on Feb. 2, 2020.

(51) Int. Cl. F02B 75/28; F02B 25/08

(52) U.S. Cl. CPC F02B 75/28; F02B 3/06; F02B 25/08

(57) ABSTRACT

A two-stroke internal combustion engine having an Atkinson ratio A and a compression ratio R_{C}, the compression ratio having a value in the range from 19 to 30, and an Atkinson ratio selected such that the product of Atkinson ratio and compression ratio is near to and generally greater than 36. The best values of this product, AR_{C}, vary slightly with the choice of compression ratio according to the following relationship: AR_{C}≥36.33+8788 e^{-0.375 Rc}. The engine includes a conventional exhaust valve and may include a high ratio of stroke length to bore, or may be of an opposed piston construction.

### BACKGROUND

We on earth (7.8 billion people in 2021) are destroying our planet by wasteful use of resources, and in particular by wasting energy. Of all the vast production of energy on the planet, now at over 600×10¹⁵ BTUs (630 EJ) per year, about 80% is from burning fossil fuels at very low efficiency. Renewable energy sources are beginning to replace fossil fuel use, but the best solution in the near term, to meet our energy needs with far less dependence on fossil fuels, is to improve energy efficiency of fuel use. Our invention—a high efficiency engine—is directed to that purpose. It is particularly useful for combined heat and power applications where a combined efficiency of 90% or more may be achieved. Our engine, or engines, are ideally suited for use with renewable fuels.

### PRIOR ART

The scientific principles of operation of internal combustion engines have been known for approximately 130 years, after Rudolph Diesel first applied the concept of the thermodynamic cycle in 1892, just 16 years after the foundation concepts were introduced by Willard Gibbs. Modern theory of the thermodynamic cycles of internal combustion engines began with Diesel's work. In Diesel's U.S. Pat. No. 608,845, he presents what has become known as the “Diesel cycle.” Today, the five well-known internal-combustion engine cycles are represented by standard reversible forms composed of isentropic, isochoric, and isobaric process steps. Those five cycles are: Diesel cycle, Otto cycle, dual cycle, Brayton cycle, and the Atkinson (or Miller) cycle. It was not generally known until recently that a sixth comprehensive standard thermodynamic cycle includes and extends the five prior cycles—we refer to this improved cycle as The General Cycle. A thorough description of the General Cycle is provided in the reference:
Ernest Rogers, “Calculating Engine Efficiency with the General Cycle Equation,” May, 2020, available on-line at the following web address:
   https://www.researchgate.net/publication/341133935_Calculating_Engine_Efficiency_with_the_General_Cycle_Equation

### BRIEF SUMMARY OF THE INVENTION

Our invention concerns the design and application of internal combustion engines having optimum efficiency, operating generally in accordance with a thermodynamic cycle called the General Cycle, and at prescribed products of Atkinson ratio and compression ratio (AR_{C}). An engine constructed in accordance with our invention having the required optimal conditions of R_{C} and prescribed AR_{C} comprises a multiplicity of volumes with enclosing structures, which volumes generally are of cylindrical form, each volume with an enclosed compressible fluid, or gas, that is cyclically compressed from a first volume to a second volume, heated by combustion, and expanded from the second volume to a third volume. These operations are performed by operation of mechanisms having parts such as pistons and valves, such that the ratio of the first volume to the second volume equals R_{C}, which is the compression ratio, and the ratio of the third volume to the first volume equals A, which is defined as the Atkinson ratio. As used to produce combined heat and power, our inventive engines produce electricity at near 60% efficiency while also providing an additional 30% or more of the input energy as high-quality heat.

### BRIEF DESCRIPTION OF THE DRAWINGS

FIG. 1 shows the P-V diagram of our engine's thermodynamic cycle which is called the General Cycle.

FIG. 2 is a graphical illustration of minimum values of AR_{C} to obtain substantially 60% or higher brake efficiency for internal combustion engines of the present invention.

FIG. 3 shows a small engine having a piston with a shaft linkage connection between the piston and a crank shaft or other power transfer means.

FIG. 4 presents an illustrative diagram for an opposed-piston engine that may be used for stationary cogeneration of electricity and heat or for transport applications.

### DETAILED DESCRIPTION

In order to describe our invention, it will be necessary to review the scientific principles pertaining to it and to define terms. As currently practiced, our invention is a two-stroke direct-injected piston engine that is represented by the General Cycle, which is explained below.

### General Cycle

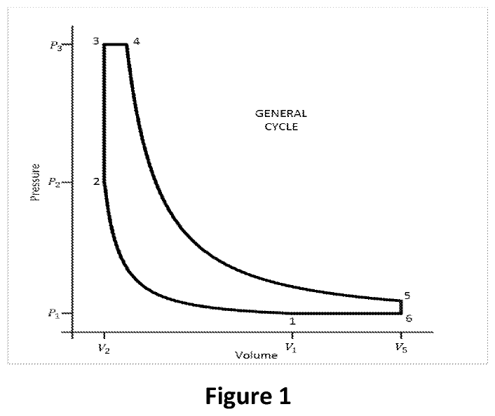

The General Cycle is an idealized thermodynamic cycle that can represent most, if not all, common internal combustion engines. Usually it is analyzed as a sequence of reversible steps performed on a compressible working fluid. In a real engine, this compressible fluid is a gas comprising oxygen with any amount of other gases, such as air or a gas composed of air, fuel, or combustion products. The General Cycle is best understood by reference to the P-V diagram of FIG. 1. It has the following steps:

I. Starting at point 1, a fresh charge of compressible fluid is compressed from volume V₁ to volume V₂. The compression ratio is R_{C}=V₁/V₂. Pressure increases from P₁ to P₂. The compression work from point 1 to point 2, defined as W₁₂, is negative.

II. Beginning at point 2, a first heat input Q₁ from fuel raises the pressure from P₂ to P₃, at constant volume. This P₃ is the maximum pressure, and V₃=V₂.

III. Beginning at point 3, a second heat input Q₂ is added at constant pressure as the piston moves outward from V₃ to V₄. Fuel had begun to burn at point 2, and burning is complete at point 4. The total heat input is Q_{IN}=Q₁+Q₂. The expansion work from 3 to 4 is W₃₄.

IV. After the hot compressible fluid (combustion gas) expands from point 3 to point 4, it continues to expand to V₅ without further heat input. The power stroke is complete at point 5. In our engines, point 5 is at a substantially greater volume than point 1. The expansion ratio is defined as R_{E}=V₅/V₂ and exceeds the compression ratio by the factor A=V₅/V₁. A is called the Atkinson ratio. It is equivalent to A=R_{E}/R_{C}. The work from 4 to 5 is W₄₅.

V. Valves open at point 5 and remain open as the piston returns to 1, the starting point. A fresh charge of compressible fluid enters as the piston moves from V₅ to V₁, then the valves close and a new cycle begins. This recharge step is inherently irreversible and represents a departure from the fully reversible cycle model. Opening the cycle causes a loss of work against the atmosphere. The work against the atmosphere, Wₐₜₘ, is negative. The total work of this cycle is W=W₁₂+W₃₄+W₄₅+Wₐₜₘ. The efficiency of the cycle is obtained by dividing the total work W by total heat input Q_{IN}.

We caution that while the above explanation of the General Cycle is of great benefit for understanding our invention, it represents a particular example and only approximates processes that may occur in a real engine built according to the invention. One may, for example, program the rate of heat input Q₂ so as to restrain the maximum gas temperature (rather than maintaining constant pressure as described above) and thereby prevent formation of nitrogen oxides by nitrogen and oxygen molecules present in the combustion gas. Such a useful variation from the General Cycle should be understood to fall within the scope of our invention.

### DESCRIPTION OF THE INVENTION

We have found that a two-stroke, direct-injected engine generally working in accordance with the General Cycle is superior to all other engines regarding the combined properties of efficiency, power density, and ease of construction. And we have for the first time found the optimum design conditions providing best efficiency for a two-stroke, direct-injected engine operating substantially in accordance with the General Cycle. Our invention concerns the application of these conditions to the construction of efficient engines. We will now describe the optimum conditions and show how they may be applied in novel, high-efficiency engine constructions.

We have found in our work that a practical upper limit of efficiency exists for internal combustion engines. For those engines of most efficient design, such as two-stroke, direct-injected engines, best efficiency lies in the general range of 60 to 65 percent brake efficiency, depending on the fuel used. In order to obtain such an optimum brake efficiency of approximately 60 percent or greater the following inequality must be satisfied:

AR_{C}≥36.33+8788e^{-0.375 Rc} (1)

For these highly efficient engines, the most desirable values of compression ratio, R_{C}, are in the range from 19 to 30, as there is no practical benefit of a compression ratio greater than 30. The design property of Inequality 1 determines highly desired values for AR_{C} (the product of Atkinson ratio, A, and compression ratio, R_{C}, and also equal to the expansion ratio, R_{E}). The following Table 1 illustrates minimum values of AR_{C} satisfying the Inequality 1 for whole number compression ratios from 19 to 30.

TABLE 1
Minimum values of Atkinson
Ratio and AR_{C} for Internal
Combustion Engines Having
Compression Ratios, R_{C}, from
19 to 30 in Order to Obtain 60%
or Greater Efficiency.

| R_{C} | A | AR_{C} |
|---|---|---|
| 19 | 2.332 | 44.3 |
| 20 | 2.062 | 41.2 |
| 21 | 1.887 | 39.6 |
| 22 | 1.755 | 38.6 |
| 23 | 1.648 | 37.9 |
| 24 | 1.559 | 37.4 |
| 25 | 1.483 | 37.1 |
| 26 | 1.417 | 36.8 |
| 27 | 1.358 | 36.7 |
| 28 | 1.306 | 36.6 |
| 29 | 1.259 | 36.5 |
| 30 | 1.216 | 36.5 |

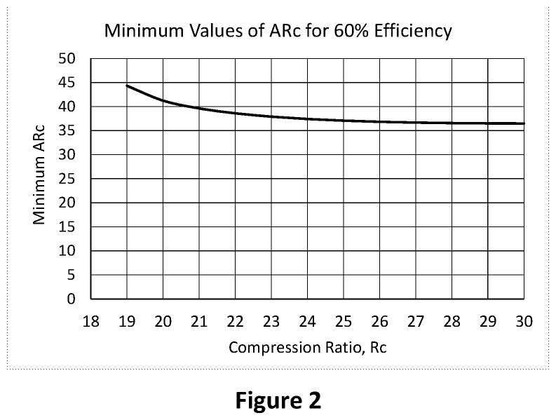

FIG. 2 illustrates the Inequality 1 and Table 1 in graphical form. One can see that the range of minimum values of AR_{C} required to produce very efficient engines of near to 60% efficiency or more is a somewhat narrow band of values greater than 36, varying from about 36.5 to 44.3 for the particular design conditions of our work. Practical engines having AR_{C} values according to the Inequality 1, which AR_{C} values are generally greater than (or equal to) those shown in Table 1 and illustrated by the graph of FIG. 2, have not been known heretofore and may be regarded as falling within the scope of our invention.

Referring to FIG. 2, it can be seen that the efficiency level of 60% obtains substantially near a lower limit value of AR_{C} approaching 36 for much of the range of compression ratios of practical importance. Therefore a simplification of the inequality formula of efficiency can be stated as:

AR_{C}≥36. (2)

Although deviations in construction of a practical engine which do not quite satisfy the original inequality may result in an engine with slightly less efficiency than 60%, it will be apparent to those skilled in the art that such an engine would still be highly efficient, and would exceed the efficiency of any practical engines known heretofore. Therefore, it should be considered that any such engine making use of the theoretical principles in its design and construction as herein set forth falls within the scope of our invention, regardless of the actual efficiency. Moreover, any engine which substantially approaches the design constraints herein set forth also falls within the scope of our invention.

We will now describe example constructions of engines designed in accordance with the principles that have been presented. In doing so we will describe per example only one cylinder and its accompanying structure, but it will be appreciated by one skilled in the art that engines are commonly composed of multiples of such similar cylinders and parts, and such constructions are within the scope of our present invention.

A First Example Engine Construction Having Backstroke Compression and a Shaft Linkage and/or Articulated Connection

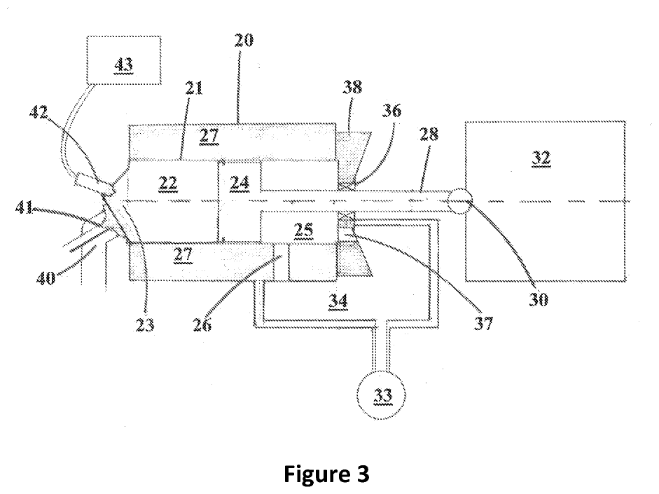

We will now show a preferred engine construction that uses piston motions to inject air into the engine, and to compress and expand the gas as performed in the General Cycle. This particular example is presented in FIG. 3. FIG. 3 shows a small engine having a piston with a shaft linkage and/or articulated connection linkage means between the piston and a crank shaft or other power transfer means. Referring now to FIG. 3, the engine 20 has an engine body 27 with a cylinder bore 21. Within the cylinder bore 21 are a cylinder volume 22 with an included chamber portion 23, a piston 24, and a back volume 25. A wall port 26 is placed in the engine body 27 in a position to provide input of a gas working fluid such as air during the recharge portion of the engine cycle. The piston 24 is connected by a shaft 28 to a power linkage means 30 which is in communication with a power transfer means 32. The shaft 28 is maintained in axial alignment with piston 24 and cylinder bore 21 by a shaft bearing and seal 36 and bearing housing 38. This shaft is provided because the stroke-to-bore ratio is too great to facilitate a direct articulated connection of a connecting rod to the piston as is common in the art.

During the recharge portion at the end of each cycle and before the beginning of the next cycle, piston 24 is in a position outward from wall port 26 so that wall port 26 is in communication with cylinder volume 22. A gas or compressible fluid such as air is introduced into cylinder volume 22 through wall port 26. This gas is obtained from a gas supply 33. The gas flows from gas supply 33 to reservoir 34, then through wall port 26 into the cylinder volume 22. An optional check valve, such as a reed valve (not shown), may be placed between the gas supply 33 and reservoir 34. This check valve can optionally serve to prevent gas from flowing back toward the gas supply 33 as the piston moves outward, reducing the back volume 25. As the piston moves outward, gas in the back volume 25 is forced out through wall port 26 and a back port 37. The back port 37, which provides for final discharge of gas from the back volume 25, may be either situated in the end portion of the engine body 27 or adjacent to the shaft bearing 36 in bearing housing 38, as shown in FIG. 3. Outward motion of the piston 24 may serve to add pressure to the gas. Shaft bearing 36 has a seal within it that prevents leakage of gas from the back volume 25. The increase in pressure in reservoir 34 from the rearward motion of the piston facilitates the flow of the fluid through wall port 26 when the piston is in its most outward position.

Additional parts connected to the combustion chamber 23 are an exhaust port 40 with a valve 41, and a fuel injector 42. Port 40 with valve 41 form a closable opening to selectably permit transfer of the fluid out of the cylinder. Fuel injector 42 receives fuel from a fuel supply system 43 to provide a heat input means to increase the internal energy of the fluid by combustion of an injected fuel.

The beginning of a cycle as defined here occurs at the time that the valve 41 is closed in the exhaust port 40 and the piston then begins to compress gas in the cylinder volume 22. However, this does not occur at the time that the piston is near to the far outward position, called bottom dead center (BDC). Rather, the piston 24 moves inward from BDC with the exhaust valve 41 open until a position is reached where the cylinder volume 22 has been reduced by a factor of 1/A from the substantially greater value V₅ referred to above in describing the General Cycle and further described below. A is the Atkinson ratio. (In the present example, A has a value of 1.4 and the desired compression ratio is R_{C}=27.)

At the time that the valve 41 is fully closed, the value of cylinder volume 22 is V₁. All valves are closed and compression of the gas, or air, in the cylinder volume 22 begins as piston 24 continues to move inward toward top dead center (TDC) position, which is the point of least cylinder volume referred to as V₂ in the above General Cycle description. This least cylinder volume is substantially the chamber volume 23. As the piston 24 arrives at substantially the TDC position, heat is added to the gas in the cylinder volume 22 (presently equal to chamber volume 23) by the injection and burning of fuel. This process continues for a short time, initially raising the gas temperature and pressure at a near-constant-volume condition, and for a brief additional time as the piston moves outward, then fuel cutoff occurs. At fuel cutoff, the cylinder volume 22 will have increased in volume to a value V₄ as described in the above General Cycle description. The heated gas, at a very substantial pressure, drives the piston farther thus sending power via the piston shaft 28, through power link 30, and to the power transfer means 32. This continues until the piston reaches an outward position approaching BDC, at which point exhaust valve 41 opens to discharge burnt gases from the cylinder volume 22. At the effective time of valve 41 opening, the volume of cylinder volume 22 is substantially equal to V₅. Shortly after, the pressure in cylinder volume 22 falls below the pressure of the gas in gas reservoir 34. As the piston 24 continues to move outward, it uncovers wall port 26. Then a fresh charge of gas displaces remaining burnt gas in the volume 22 and fills the volume 22 with a fresh charge of gas. The replenishing of the cylinder volume 22 with fresh gas continues for a length of time while the piston 24 completes its travel to BDC and where it then reverses direction, and covers the wall port 26 again by its inward motion. The valve 41 remains open for a further time as the piston continues to move inward. The valve 41 closes at the point where the cylinder volume 22 has returned to the value V₁. This is the point of beginning of a new cycle.

This two-stroke engine operating at an effective input pressure P₁=115 kPa (1.15 bar) and having a compression ratio of R_{C}=27 has excellent fuel utilization for a broad range of renewable and fossil fuels. It gives good specific power and substantially 60% brake efficiency or greater, depending on the fuel that is used. The engine has the following operating characteristics operating on No. 2 diesel fuel (ASTM D975-19a, 2-D (S-15) at 70% of stoichiometric mixture:

| Compression ratio, Rc | 27 | |
|---|---|---|
| Atkinson ratio, A | 1.40 | |
| AR_{C} | 37.8 | |
| Inlet pressure, P₁ | 115 | kPa |
| Peak cylinder pressure | 21 | MPa |

| | |
|---|---|
| Fuel ignition temperature at TDC | 1310K |
| Brake efficiency | 60% |

As an example, this small engine has dimensions of:

| | | |
|---|---|---|
| Bore, B | 83 | mm, |
| Stroke, S | 195 | mm, |

| | |
|---|---|
| Stroke-to-Bore, S/B | 2.35 |

At 1200 RPM, a mean piston speed of 8.0 meters per second.

| | |
|---|---|
| Specific power | 24.0 hp per liter |

Other fuels are also being evaluated:

Eli) gasoline (ASTM D4814-19, 10% ethanol)—efficiency is 60%

Fuel methanol (ASTM D5797, M100)—efficiency is above 64%

The above small engine shown in FIG. 3 as well as other internal combustion engines built according to the condition of Inequality 1 operate at substantially 60% efficiency or better. Note that in this engine the AR_{C} value of 1.4×27=37.8 is somewhat greater than the minimum AR_{C} of Table 1. By using a higher value of AR_{C}, design conditions such as inlet pressure and maximum cylinder pressure may be relaxed.

Fuel flexibility is an important benefit of our high-compression, high-efficiency engines. Except for changes in fuel injection means, the engine of FIG. 3 operates without modification on virtually any liquid or gaseous fuel. Some fuels such as methanol and methane are readily produced from renewable sources such as organic wastes. This is a significant benefit for prevention of global warming and climate change. We will now describe an especially preferred embodiment and set of design conditions for our engines that are well suited for construction of cogeneration units.

### A Second Example Preferred Engine Construction for Renewable Cogeneration of Electricity and Heat

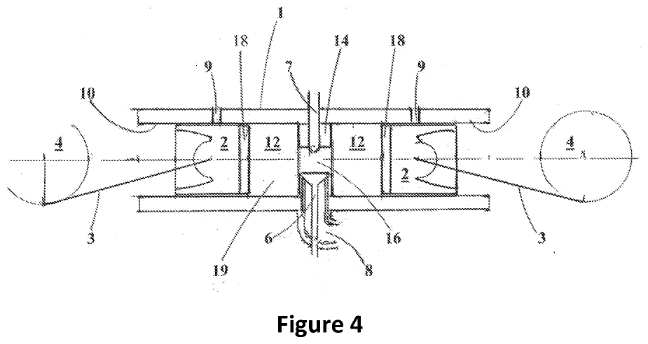

An especially preferred engine for cogeneration of heat and electric power, and satisfying Inequality 1, is shown in FIG. 4. Referring now to FIG. 4, what is shown is a schematic diagram for a two-stroke, compression ignition, direct-injected opposed-piston engine. The engine has a substantially symmetrical construction regarding many of its parts; these duplicate parts are labeled with the same part number. The engine body 1 has two axially-aligned cylindrical bores 10 containing pistons 2 that move in opposition to each other. The bores 10 and pistons 2 enclose two volumes 12. The two volumes 12 are separated from each other by a partition 14. However, the volumes 12 are always in communication with each other through a connecting combustion chamber 16 which passes through partition 14 and thus the two volumes 12 work cooperatively as a single cylinder volume in the engine body 1. The partition 14 is composed primarily of a fracture-tough ceramic material such as a fine-grained zirconium dioxide material. Within the partition 14 are the combustion chamber 16 formed within the ceramic material, a fuel injector 7, and an exhaust port with valve 6.

A ceramic face 18 is applied to each of the pistons 2. This ceramic material is applied by plasma or flame spraying or other means and in a sufficient thickness to substantially reduce heat transfer from the hot gases to the piston bodies. The combination of the ceramic combustion chamber 16 and the ceramic piston faces 18 is an important optional aspect of our invention as it greatly reduces energy loss by heat transfer.

In the first portion of the engine cycle, the pistons 2 move toward the partition 14, approaching it very closely as they reach their top dead center (TDC) positions. In so doing, they compress a compressible fluid or gas 19 into the combustion chamber 16. This gas 19 may comprise oxygen, air, combustible gas or vapor, or any combination of suitable gases. Heat is introduced into the combustion chamber 16 by injection of fuel through fuel injector 7, which fuel almost immediately commences burning in cooperation with the compressed gas 19, thus forming a combusted gas at high temperature and pressure. In the next portion of the cycle, the pistons 2 move outward, transferring energy to crankshafts 4 by means of connecting rods 3. This is the power stroke of the engine. The two rotatable crankshafts are mounted in relation to the engine body, and the connecting rods or linkages between each crankshaft and its associated piston drive the pistons or extract energy from the movement of the pistons. The crankshafts are timed to advance the pistons at substantially the same time. The power stroke ends as the pistons 2 draw near to uncovering wall inlet ports 9. The exhaust port with valve 6 opens at the end of the power stroke, and combusted gas is discharged from the cylinder volume. This cylinder volume is composed of combined volumes 12 and chamber 16. The combusted gas is discharged through an exhaust manifold system 8. Shortly afterward, the pistons 2 pass outward sufficiently to uncover wall intake ports 9. While the pistons 2 are outward past the wall ports 9, gas 19 enters through the wall ports 9 and displaces remaining burnt gas within the cylinder volumes 12 and chamber 16. As the pistons 2 reach BDC, they reverse their direction of motion and begin to move inward again.

A third portion of the cycle comprises the operation of the engine between the time of beginning of inward motion of the pistons 2 and the time at which the engine again begins to compress gas for a new cycle. During this time interval, the pistons move a substantial distance inward. The end of the interval is defined by the effective closure of the exhaust valve 6. A key aspect of our invention concerns the positions of pistons 2 and the total operating volume of the engine at the times of opening and closing of the exhaust valve 6. The total operating volume is equal to the volume of the combustion chamber 16 plus the combined volumes of the two volumes 12. This total operating volume will now be referred to simply as “V” with a designating subscript that indicates the value of V at a particular point in the engine's cycle. With reference to the P-V diagram of FIG. 1, at the time that the exhaust valve 6 closes, the volume of V is V₁. When the pistons reach TDC, the value of V is V₂, which is substantially equal to V₃. At the end of heat addition, the value of V is V₄, and at the end of the power stroke, which is at the effective time of opening of the exhaust valve 6, the value of V is V₅. In accordance with our invention, the various values of V satisfy the following conditions:

V₂/V₁=R_{C}

V₅/V₁=A

And AR_{C}≥36.33+8788 e^{-0.375 Rc} as has been discussed in detail above.

This second preferred engine construction is considered to be of great value for use in distributed power generation. The engine is imagined to be coupled to one or more electric generators of any desired type. In addition, the waste energy is to be collected at available locations. Approximately 60% of the energy in the engine fuel will be delivered as work to the electrical generator(s). Of that work, as much as 96% to 98% may be converted to electrical energy. The waste energy comprises approximately 40% of the energy in the engine's fuel. A portion of that energy may be collected in the form of high-quality heat. The efficiency of collection and transfer of this heat may be in the general range of 75% to 80%. The heat is referred to as being of high quality because it can be collected at a very substantial temperature, in the general range of 100 degrees Celsius to as much as 300 degrees to 400 degrees Celsius. High-quality heat has great practical value for heating, producing hot water or steam, and for industrial process heat. Combining the two system efficiencies, the engine's efficiency of producing electrical power with the efficiency of collection and use of heat, provides an overall system efficiency of approximately 90%. In this fashion, our invention can be of immense value in reducing dependence on fossil fuels, or fuels of any kind. Our engines may use any of several suitable fuels such as natural gas or biomethane, dimethyl ether, methanol, diesel fuel, gasoline, or a combination of fuels. Some of these fuels may be obtained from renewable as well as geologic sources. Basic physical properties and design parameters of the above example engine are:

| Cylinder Bore | 7.125 | in (0.181 m) |
|---|---|---|
| Piston stroke (each side) | 9.250 | in (0.235 m) |
| Cylinder length | 38.4 | in (0.976 m) |
| Cylinder displacement | 10.0 | liters |
| Wall inlet port each side | 1.825 | in (0.0463 m) |
| RPM for synchronous generation | 900 | rpm |
| Compression ratio | 25 | |
| Atkinson ratio | 1.52 | |
| AR_{C} | 38 | |
| Inlet pressure | 120 | kPa (1.20 bar, 17.4 psia) |
| Inlet temperature | 360 | k (188 deg. F.) |
| Maximum pressure | 22.0 | MPa (3200 psia) |

As mentioned, our cogeneration engine described above can provide both heat and electricity with a combined efficiency of 90% or greater, and causes no net increase in atmospheric greenhouse gas (e.g., CO₂) in its operation when using a renewable fuel. This engine combined with a synchronous generator has a fuel consumption of approximately 0.148 kg/kWh when operating on ultra-low-sulfur diesel fuel. Electrical generation is at approximately 57% efficiency. Thus, our new engine technology represents a great advance toward reduction of global warming and climate change.

What is claimed is:

1. An internal combustion engine operating generally in accordance with a thermodynamic cycle called the General Cycle comprising:
a cylinder;
a compressible fluid within one end of the cylinder;
a piston mounted to slide within the cylinder to alternatingly compress and expand the fluid;
a heat input means to increase internal energy of the fluid by combustion of an injected fuel;
at least one closable opening within the cylinder to selectably permit transfer of the fluid into or out of the cylinder;
energy transfer means in communication with the piston to move the piston or to extract energy from the movement of the piston;
the fluid alternatingly being compressed by a ratio of compression denoted as R_{C}, and being expanded by a ratio of expansion denoted as R_{E}, and the Atkinson ratio being denoted as A and defined as A=R_{E}/R_{C};
the engine operationally satisfying the inequality: AR_{C}≥36.33+8788 e^{-0.375 Rc}.

2. The internal combustion engine of claim 1 having a compression ratio between 19 and 30.

3. An internal combustion engine operating generally in accordance with a thermodynamic cycle called the General Cycle comprising:
a cylinder;
a compressible fluid within one end of the cylinder;
a piston mounted to slide within the cylinder to alternatingly compress and expand the fluid;
a heat input means to increase internal energy of the fluid by combustion of an injected fuel;
at least one closable opening within the cylinder to selectably permit transfer of the fluid into or out of the cylinder;
linkage means attached to the piston to drive the piston or to extract energy from the movement of the piston;
the fluid alternatingly being compressed by a ratio of compression denoted as R_{C}, and being expanded by a ratio of expansion denoted as R_{E}, and the Atkinson ratio being denoted as A and defined as A=R_{E}/R_{C};
the engine operationally satisfying the inequality: AR_{C}≥36; and
the engine having a compression ratio between 19 and 30.

4. An internal combustion engine comprising:
a cylinder having a normally closed end which contains a compressible fluid within the closed end of the cylinder, and a back end of the cylinder opposite the closed end;
a closable exhaust opening in the closed end of the cylinder to selectably permit transfer of the fluid out of the cylinder;
a piston mounted to slide within the cylinder to alternatingly compress and expand the fluid, the piston having a front side facing the compressible fluid, and a back side opposite the front side;
linkage means attached to the piston to drive the piston or to extract energy from the movement of the piston;
an intake port opening in the cylinder positioned to allow fluid to enter the cylinder in communication with the normally closed end of the cylinder when the back side of the piston is substantially adjacent the back end of the cylinder;
fluid supply means providing fluid to the intake port opening; and
fuel supply means for adding fuel to the compressible fluid in the closed end of the cylinder.

5. The internal combustion engine of claim 4 wherein the exhaust opening is timed in conjunction with the sliding of the piston to remain open for a portion of the time in the forward movement of the piston beyond the time at which the intake port opening is covered by the piston.

6. The internal combustion engine of claim 4 wherein the compression ratio of the compressible fluid is between 19 and 30, and the expansion ratio is greater than 36.

7. The internal combustion engine of claim 4 wherein the linkage means comprises a shaft attached axially to the back side of the piston and extending beyond the back end of the cylinder.

8. The internal combustion engine of claim 4 further comprising a fluid reservoir in communication with the intake port and the fluid supply means.

9. The internal combustion engine of claim 4 further comprising a fluid reservoir, a wall port communicating between the reservoir and the interior of the cylinder, and a back port communicating between the back side of the cylinder and the reservoir, with the operational rearward motion of the piston increasing the pressure in the reservoir.

10. An internal combustion engine comprising:
an engine body with two axially aligned cylindrical bores;
two pistons slidably positioned within the bores to move in opposition to each other, and containing within the cylindrical bores and the pistons a compressible fluid;
a partition in the engine body between the cylindrical bores separating the compressible fluid into two volumes which are in open communication to work cooperatively, the partition forming a combustion chamber into which the compressible fluid is substantially compressed when the pistons approach the partition;
an exhaust port with a valve therein within the engine body and the partition to selectably permit transfer of the compressible fluid out of the engine body; and
inlet means in the engine body for supplying compressible fluid into the cylindrical bores.

11. The internal combustion engine of claim 10 further comprising injection means within the engine body and the partition for adding fuel to the compressible fluid.

12. The internal combustion engine of claim 10 wherein the partition is formed of ceramic material.

13. The internal combustion engine of claim 10 wherein the faces of the pistons facing the compressible fluid are covered with ceramic material.

14. The internal combustion engine of claim 10 wherein the compression ratio of the compressible fluid is between 19 and 30, and the expansion ratio is greater than 36.

15. The internal combustion engine of claim 10 further comprising two rotatable crankshafts mounted in relation to the engine body, and linkages between each crankshaft and its associated piston to drive the pistons or to extract energy from the movement of the pistons, the crankshafts being timed to advance the pistons at substantially the same time.
